(19) United States
(12) Patent Application Publication
(10) Pub. No.: US 2013/0327436 A1
(43) Pub. Date: Dec. 12, 2013

(54) FLAME-RETARDANT PLASTICS PIPING SYSTEM

(71) Applicant: Georg Fischer Rohrleitungssysteme AG, Schaffhausen (CH)

(72) Inventor: Oliver Hein, Langwiesen (CH)

(21) Appl. No.: 13/908,573

(22) Filed: Jun. 3, 2013

(30) Foreign Application Priority Data
Jun. 6, 2012 (EP) 12 170 968.7

(51) Int. Cl. F16L 57/04

(52) U.S. Cl. CPC F16L 57/04
USPC 138/146; 427/223; 427/322; 427/536; 427/412.4; 427/412.3; 427/412.1; 427/427.6; 427/428.01; 427/430.1; 427/393.5

(57) ABSTRACT

Process for the production of a flame-retardant plastics piping system which comprises piping components, in particular piping and connecting elements, such as fittings, valves, screw-threaded elements, containers, pumps, and to which, on the exterior surface of the plastics piping system, an intumescent water- or solvent-based coating comprising a crosslinking binder, in particular at least one of the following binders: vinyl acetate, epoxy resin, acrylate, acrylate mixed resin, polyurethane, polyurethane-acrylate, and various fillers, is applied, where a protective layer is applied over the intumescent coating.

### BACKGROUND OF THE INVENTION

The invention relates to a process for the production of a flame-retardant plastics piping system which comprises piping components, in particular piping and connecting elements, such as fittings, valves, screw-threaded elements, containers, pumps, etc., and to which, on the exterior surface of the plastics piping system, an intumescent water- or solvent-based coating comprising a crosslinking binder, in particular at least one of the following binders: vinyl acetate, epoxy resin, acrylate, acrylate mixed resin, polyurethane, polyurethane-acrylate, and various fillers, is applied, and also to the flame-retardant plastics piping system.

In sectors where a relatively high level of fire protection is required, i.e. the requirement is not only that the materials used make no contribution to any increase in fire loading but also must withstand a fire for a prescribed time, the general practice hitherto has been to use metal piping systems. Piping systems made of metal are used only with great reluctance in application sectors where it is advantageous to provide piping systems which have low weight or are corrosion-resistant, for example on ships. Plastics piping systems are alternatives here, but these have only restricted usefulness because conventional plastics piping systems are unsuitable for areas requiring fire protection, since they do not withstand fire and immediately decompose and thus provide an additional increase in fire loading; they are moreover also unsuitable for extinguishment-water lines.

There are known plastics that are flame-retardant. To this end, flame-retardant additives, such as brominated flame retardants, chlorinated organophosphates, metal hydroxides, metal oxides or organophosphates are admixed, with the plastic. This plastic, which has admixed additives is used to produce piping and piping components. However, there are some fluids that cannot be conveyed in piping systems of this type with altered physical properties of the plastic by virtue of the addition of the flame-retardant additives. Compound plastics of this type are not permitted in the drinking-water sector, and cannot therefore be used for piping systems for drinking water.

The prior art also discloses flame-retardant plastics pipes produced from different layers. The material of the inner layer is a conventional plastic which complies with the requirements for approval for drinking water. The exterior layer is a fire-resistant layer, which provides flame retardancy around the inner layer, either by virtue of a plastic which has a flame-retardant additive and which has been co-extruded around the inner pipe or by virtue of a fire-resistant fibre covering on the piping, as disclosed in EP 0 660 020 B1. Multilayer fire-protection composites of this type have good suitability for the production of piping. However, this type of flame retardancy cannot be used for the production of connecting elements, such as fittings, valves, etc. EP 0 857 272 B1 equally discloses a fire-resistant pipe surrounded by the winding of a reinforcing fibre and using a resin for adhesive-bonding. This type of fire protection is very expensive to produce and again when applied to connecting elements is expensive and very difficult or almost impossible to use.

US 2010/0084037 describes a process for the application of a coating to a flexible tubular component. The coatings which are applied by the said process serve to improve the UV resistance of the flexible tubular component, and also serve as oxygen barrier. The coating is moreover resistant to mechanical effects, such as scratching and other abrasive occurrences. However, the coatings applied by the said process are not suitable as fire protection or flame retardancy.

It is an object of the invention to propose a process for the production of a flame-retardant plastics piping system, and also the flame-retardant plastics piping system itself, by virtue of which it is possible to apply an intumescent coating suitable for fire protection to a plastics piping system inclusive of connecting elements, and despite the environmental effects having an adverse effect on the coating, for example moisture, wear, etc., the coating dependably provides its function of fire protection.

### SUMMARY OF THE INVENTION

The foregoing object is achieved by providing a protective layer applied over the intumescent coating.

### DETAILED DESCRIPTION

As previously mentioned above, intumescent coatings are prior art. In the construction sector there are known coatings that produce foam, forming an insulating layer around a steel girder. However, application of this type of layer or coating to a base made of plastic requires a specific process for reliable provision of adhesion, mechanical stress, flexibility and a high level of fire protection. The advantage of that type of coating is that it can be applied not only to the piping but also to connecting elements, and that the entire plastics piping system therefore has flame retardancy. Piping systems comprise not only the piping but also connecting elements, such as fittings, valves, screw-threaded elements, containers, pumps and other elements. The piping system is preferably composed of at least one of the following plastics: PVC-U, PVC-C, ABS, PP, PE and/or PB; it is not necessary here that the individual components of the system have been produced from the same plastics, but it is conventional that a system is composed of one type of plastic.

The intumescent coating which is applied to the plastics piping system is water- or solvent-based and comprises at least one crosslinking binder, e.g. vinyl acetate, epoxy resin, acrylate, acrylate mixed resin, polyurethane, polyurethane-acrylate, and various fillers, such as melamines, ammonium polyphosphates or polyalcohols.

It is necessary to clean the exterior surface of the plastics piping system before application of the coating. It is preferable to use solvents or surfactants for this purpose. As an alternative to this, it is also possible to use particle bombardment or dry ice bombardment to clean the surface.

In another step of the process, the exterior surface of the plastics piping system is flame-treated. Plasma treatment is a possible alternative to the flame treatment. In flame treatment, the plastic is treated with an open flame. Directly after the flame treatment or the plasma treatment, the intumescent coating is applied. In a possible method for improving the adhesion of the intumescent layer on the plastics piping system, an adhesion promoter is applied prior to application of the intumescent layer. This adhesion promoter can be applied after flame treatment or plasma treatment or can replace the same.

The intumescent coating is preferably applied by spraying, and it is possible here to apply a plurality of layers in succession, giving increased layer thickness. In an alternative, the layer can also be applied by rolling or dip-coating. The thicker the layer, the higher the temperatures to which the plastics piping system can be exposed. However, the coating should have a minimum thickness or dry-layer thickness of 0.3 mm in order to provide suitable fire protection.

A protective layer is applied to the intumescent coating to provide protection from environmental effects, such as moisture, cleaning compositions, etc. The protective layer is a layer of water- or solvent-based coating material, and is preferably applied by spraying. The thickness of this layer or dry layer is preferably in the range from 0.02 to 0.15 mm.

The plastics piping system is thermally post-treated after application of the layer.

1. A process for the production of a flame-retardant plastic piping system comprising plastic piping components, comprising the steps of:
(a) providing an intumescent coating comprising a crosslinking binder wherein the binder is selected from the group consisting of vinyl acetate, epoxy resin, acrylate, acrylate mixed resin, polyurethane, and polyurethane-acrylate on the plastic piping components; and
(b) applying a protective layer over the intumescent coating to produce a flame-retardant plastic piping system.

2. A process according to claim 1, wherein the plastic piping components are composed of a plastic selected from the group consisting of PVC-U, PVC-C, ABS, PP, PE, PB and mixtures thereof.

3. A process according to claim 2, wherein surfaces of the plastic components are cleaned prior to applying the intumescent coating.

4. A process according to claim 2, wherein surfaces of the plastic components are flame-treated.

5. A process according to claim 2, wherein surfaces of the plastic components are plasma-treated.

6. A process according to claim 2, including applying an adhesion promoter to surfaces of the plastic components prior to applying the intumescent coating.

7. A process according to claim 1, wherein the intumescent coating is applied by spraying.

8. A process according to claim 1, wherein the intumescent coating is applied by rolling.

9. A process according to claim 1, wherein the intumescent coating is applied by dip-coating.

10. A process according to claim 1, wherein the protective layer comprises a layer of coating material based on solvents.

11. A process according to claim 1, wherein the protective layer comprises a layer of coating material based on water.

12. A process according to claim 1, including thermally treating the plastic components after applying the protective layer.

13. A process according to claim 1, wherein the intumescent coating is one of water-based and solvent-based.

14. A flame-retardant plastic piping system comprises piping components, wherein exterior surfaces of the piping components have an intumescent coating comprising a crosslinking binder wherein the binder is selected from the group consisting of vinyl acetate, epoxy resin, acrylate, acrylate mixed resin, polyurethane, and polyurethane-acrylate; and a protective layer over the intumescent coating to produce a flame-retardant plastic piping system.

15. A flame-retardant plastic piping system according to claim 14, wherein the intumescent coating has a minimum thickness of 0.3 mm.

16. A flame-retardant plastic piping system according to claim 14, wherein the protective layer has a thickness of from 0.02 to 0.15 mm.
